(19) United States
(12) Patent Application Publication
(10) Pub. No.: US 2011/0077994 A1
(43) Pub. Date: Mar. 31, 2011

(54) OPTIMIZATION OF WORKFORCE SCHEDULING AND CAPACITY PLANNING

(75) Inventors: Wasserkrug Eliezer Segev, Haifa (IL); Zohar Feldman, Haifa (IL); Dagan Gilat, Haifa (IL)

(73) Assignee: International Business Machines Corporation, Armonk, NY (US)

(21) Appl. No.: 12/570,225

(22) Filed: Sep. 30, 2009

(51) Int. Cl. G06Q 10/00; G06N 5/02; G06F 17/11

(52) U.S. Cl. 705/9; 706/52; 703/2

(57) ABSTRACT

A computer implemented method for solving a scheduling or capacity planning problem of a workforce of a service center, given an anticipated workload, is disclosed. The method includes the steps of calculating the number of workers and skills required in order to supply the adequate level of service; determining the number of workers required at a given period of time; and assigning specific workers subject to specific constraints to a specific period of time, by constructing and solving a mixed integer programming problem. The steps are implemented in either of computer hardware configured to perform said steps and computer software embodied in a non-transitory, tangible, computer-readable storage medium. Also disclosed are corresponding computer program product and data processing system.

### BACKGROUND

The present invention relates to automated optimization methods and systems, and more specifically, to methods and systems for automated optimization of a workforce providing services at a service center.

For many, if not all, enterprises and organizations, the workforce is the most important asset, and a main source for cost and expenses. Managing a workforce providing services at a service center is an intricate task that involves many skills and is regarded by many businesses as a major key to the success of the business.

Attempts were made to present methods and systems for optimization of a given workforce.

### SUMMARY

According to one embodiment of the present invention a computer implemented method is disclosed for solving a scheduling or capacity planning problem of a workforce of a service center given an anticipated workload. The method includes the steps of calculating the number of workers and skills required in order to supply the adequate level of service; determining the number of workers required at a given period of time; and assigning specific workers subject to specific constraints to a specific period of time, by constructing and solving a mixed integer programming problem.

These steps are implemented in either of a) computer hardware configured to perform said steps; b) computer software embodied in a non-transitory, tangible, computer-readable storage medium.

Furthermore, in accordance with some embodiments of the present invention, a computer program product stored on a non-transitory tangible computer readable storage medium for optimizing the work of a workforce given an anticipated workload is disclosed. The computer program product includes computer useable program code for calculating the number of workers and skills required in order to supply the adequate level of service; computer useable program code for determining the number of workers required at a given period of time; and computer useable program code for assigning specific workers subject to specific constraints to a specific period of time, by constructing and solving a mixed integer programming problem.

Furthermore, in accordance with some embodiments of the present invention, there is provided a data processing system that includes a processor; a computer usable medium connected to processor, wherein the computer usable medium contains a set of instructions for solving a scheduling or capacity planning problem of a workforce of a service center, wherein the processor is adapted to carry out a set of instructions to calculate the number of workers and skills required in order to supply the adequate level of service; to determine the number of workers required at a given period of time; and to assign specific workers subject to specific constraints to a specific period of time, by constructing and solving a mixed integer programming problem.

### BRIEF DESCRIPTION OF THE SEVERAL VIEWS THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic overview of a method for optimizing the use of a workforce in a workplace, according to an embodiment of the present invention.

FIG. 2 is a flow chart of an algorithm for solving workforce scheduling or capacity planning, according to some embodiments of the present invention.

FIG. 3 illustrates an automated system for optimization of a workforce, according to embodiments of the present invention.

FIG. 4 illustrates an automated system for optimization of a workforce, according to embodiments of the present invention, implemented in a communication network.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Flowchart/s and block diagram/s in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of the present invention include methods and systems for automated optimization of a workforce, directed at finding optimized scheduling or capacity planning of a given workforce providing services at a service center.

Workforce management of a workforce providing services at a service center involves two important aspects:

Capacity Planning (CP), which deals with finding the optimal workforce composition required to meet the strategic/business objectives of the enterprise; and

Workforce Scheduling (WS), which deals with planning ahead for a given (typically short) time period (up to several weeks), the assignment of the each individual of the workforce to a specific shift or time slot.

According to embodiments of the present invention, for both of the abovementioned aspects in order to solve the both overall problem (CP and/or WS) in a holistic manner, it is necessary to solve the following four sub-problems:

A. Anticipating the workload for a given period of time (e.g. work shift or a time slot);

B. Calculating the number of workers and skills required in order to supply the adequate level of service;

C. Determining the number of workers required at a given period of time; and

D. Assigning specific workers subject to specific constraints to a specific period of time.

Anticipated future workload for a given period of time that must be handled by the employees may include, for example attending phone calls in contact centers, and handling of complex business processes (e.g. loan approvals in banks, and claim handling in an insurance environment). This can be handled by standard forecasting methodologies, and is not a novel aspect of the present invention. For the purposes of embodiments of the present invention it is assumed that future workload is given or otherwise predetermined.

In calculating the number of workers required to maintain an adequate level of service one may consider business objectives that must be addressed, such as for example, a specific service level (or levels) that it is desired to maintain during specified time periods (e.g., 80% of the monthly calls must be answered within 20 seconds, 90% of loan processes must be complete within 60 days, a 20% market share is to be maintained, the number of returning customers is to be increased),

In determining the number of workers and skills required at a given period of time and in assigning specific workers to specific periods of time one may consider, for example, attributes of the employees, which are relevant to operational planning described above, for example, individual employee set of personal skills (e.g., a person who must be able to answer phone calls in French—French being a skill), work scope: (e.g. whether the employee is a part time or full time employee, the number of working hours per day/week/month of a certain employee, how many vacation days an employee has per year), individual constraints of employees, which may include, for example, individual employee availability throughout the year, employee capabilities, e.g., speed or efficiency of an employee on a certain task and employee preferences regarding work hours, operational constraints, which in many cases are specific to the scheduling/capacity planning problem that must be addressed, for example, minimum resting hours between consecutive shifts for each employee that must be maintained, and stochastic factors, which may include, for example, the future workload that must be taken into account, the uncertainty regarding this workload may be considered too (e.g., arrival process, amount of work required from an employee on each such work item).

According to some embodiments of the present invention, it is suggested to solve sub-problem D of assigning specific workers subject to specific constraints by constructing and solving a MIP (mixed integer programming) problem corresponding to this sub-problem.

According to some other embodiments of the present invention, it is further suggested to solve both sub-problems C and D (determining the number of workers required at a given period of time and assigning specific workers subject to specific constraints) by constructing and solving a corresponding MIP problem.

According to yet some other embodiments of the present invention, it is also further suggested to solve three sub-problems, namely sub-problems B, C and D (calculating the number of workers and skills required in order to supply the adequate level of service while taking all necessary stochastic factors into account, determining the number of workers required at a given period of time and assigning specific workers subject to specific constraints) by constructing and solving a corresponding MIP problem, and employing a stochastic model to evaluate service levels obtained when applying the solution of the MIP problem.

Thus the scheduling and/or capacity planning problem, according to some embodiments of the present invention, may be solved by concurrently addressing several sub-problems, rather than dividing it to sub-problems and solving each sub-problem individually. Moreover, complex service models (e.g. business processes) may be accommodated for. In the proposed model, according to some embodiments of the present invention, a wide variety of complex business rules stemming from work regulations and requirements may be taken into account, as well as service level objectives that can take a very wide range of forms, and may be expressed on various time horizons (daily, weekly etc.). The proposed approach, according to some embodiments of the present invention, may also be used to identify solutions that minimize violations of the business objectives under certain restrictions on staffing levels. Finally, as a MIP model is used for individual scheduling, according to some embodiments of the present invention, it is possible to extend the MIP model to incorporate additional optimization decisions, such as, for example, finding the optimal set of shifts for a given team.

In an algorithm, according to some embodiments of the present invention, MIP and simulation are iterated in the following manner:

1. The capacity planning/scheduling problems is modeled as a MIP problem. The decision variables of the model are binary variables which represent actual assignments of employees to shifts. In the scheduling mode, actual data on existing workforce with their profiles is taken as input, whereas in the capacity planning mode actual data is used or dummy employees with diverse profiles could be created, according to declared maximal capacities.

Business constraints stemming from workforce regulations and business rules are translated into linear constraints. According to some embodiments of the present invention all constraints except for the service level objectives are translated to linear constraints.

2. The MIP problem is solved so as to obtain an optimal schedule. The attained schedule and the operational business processes data are used to create a stochastic (e.g. simulation) model and the attained schedule is evaluated in this stochastic model to estimate performance metrics to be compared against Service Level Agreement (SLA). A very broad SLA specification may be accommodated for. SLAs may be defined for a specific process, and even in some cases for specific steps of the process. A great variety of service level objective definitions for various domains, e.g. the fraction of calls that are admitted to service before X time units, or the fraction of load tickets that were resolved within Y time units etc may be possible. Moreover, SLAs may also be defined over specific time basis, e.g. the fraction can be taken over daily basis, weekly basis, monthly and so on. If all constraints are met, we return the optimal solution. In another embodiment of the present invention, a good enough tradeoff between being near enough the service levels, and only violating some constraints, may also serve as a stopping condition.

According to some embodiments of the present invention, if the solution found so far is not satisfactory, new linear constraints (cuts) may be added to the MIP model, corresponding to violated service level objectives from a previous iteration, and a new iteration commences.

According to some embodiments of the present invention, an optimal schedule of a workforce may be obtained by translating the problem into a MIP model. Assignment variables are created for all the existing employees which indicating for each employee and day a specific shift assignment.

Then, the workforce regularities and various business rules previously defined in the system are translated into linear inequalities, taking into account employee profiles, skills and other optional parameters, such as employee preferences and availability, rules priority and so forth.

The following solution to a scheduling problem, according to some embodiments of the present invention, is given by way of an example.

Let X_{e,d,s} be a binary assignment variable indicating whether employee e is scheduled to shift s on day d. Then, the requirement that a certain employee e1 be scheduled according to the extent of the job of that employee, (e.g. at least 3 assignments per week but not more than 5) is translated into the following inequality:

$$3 \leq {\sum }_{s , d} {x}_{{e}_{1} , d , s} \leq 5$$

In the capacity planning mode, a prior workforce may or may not have to be considered. Assignments for all existing employees are created in the same way as in the scheduling problem. Additional dummy employees are generated and added to the existing team with profiles and skills according to predefined quantities which dictates the maximal number of additional employees with given skill set that could be added to the existing team. Those dummy employees may be used in case the existing team is insufficient to meet the business goals. A penalty is then added for each employee that participates in the schedule to ensure the minimal number of employees. This is done by creating an indicator Iₑ for each employee, indicating if the employee is scheduled to any shift in the schedule, and adding the indicator to the MIP objective function. This may be done by modifying the job extent constrains:

$$3 {I}_{{e}_{1}} \leq {\sum }_{s , d} {x}_{{e}_{1} , d , s} \leq 5 {I}_{{e}_{1}}$$

Stochastic models, such as, for example, simulation models, may be used in order to evaluate the service levels. A simulation model (or any other stochastic model) is created which may be based, on one hand on service system processes, definitions and parameters (the process flow, arrival rates, service times etc.), and on the other hand on staffing level x derived from the solution obtained from the MIP. The staffing levels vector x indicates how many agents having any skills set configuration are in place at any time in the planning horizon, divided to small time intervals. Namely x=(x_{1,1},K,x_{1.T},x_{2,1},K x_{S,1},K x_{S,T}), where x_{s,t} is the number of agents with skill set sε{1,K,S} at time interval tε{1,K,T}.

In case there are some violations from the SLA (e.g. one or more of the constraints are violated, for example, the simulation shows that the percentage of tickets resolved within 1 day is smaller than dictated by management), new cuts may be created based on a convexity theory. denoting all service level objectives by fₖ(x) for staffing levels x the gradient inequality may be used to deduce the cuts

∇fₖ(x*)^{T}x≦fₖ(x*)^{T}x*−fₖ(x*),

where x* is the optimal solution to the MIP problem from previous iteration, and ∇fₖ(x) is a subgradient of the service level objective with respect to the staffing levels x. If fₖ(x) is convex, this can be shown to provide an optimal solution by convexity theory. These linear inequalities are added for each violated service level constraint, given without the loss of generality by the form fₖ(x)≦0. This may ensure that in the next iteration, the number of assigned people will increase.

The subgradients ∇fₖ(x) may also be derived, e.g. numerically, by using the simulation or another stochastic model. There may be several alternatives to compute subgradient. For example, a very common method is called the finite differences. According to this method, the derivative of fₖ(x) with respect to the number of employees xᵢ with a given skill set at some given time interval is calculated by the following formula

$${[ ∇ {f}_{k} ( x ) ]}_{i} = \frac{{f}_{k} ( x + {ce}_{i} ) - {f}_{k} ( x )}{c} ,$$

where eᵢ is a vector of the same dimension as x, with zeros entries except for the i'th entry which is 1, and c is some constant.

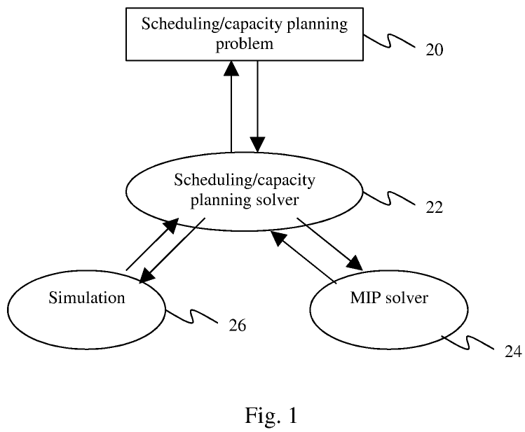

An overview of a method for optimizing the use of a workforce in a workplace, according to an embodiment of the present invention is illustrated in FIG. 1.

A scheduling (or capacity planning) problem is presented 20 to solver 22. Solver 22 uses MIP solver 24 to translate the problem into an MIP problem and solve it, and the MIP solution is simulated in simulation 26, to determine if any of the SLA constraints are violated. The process is carried out iteratively until a solution is reached that does not violate any of the SLA constraints, or until an acceptable tradeoff between violating the SLAs or violating other constraints, is found.

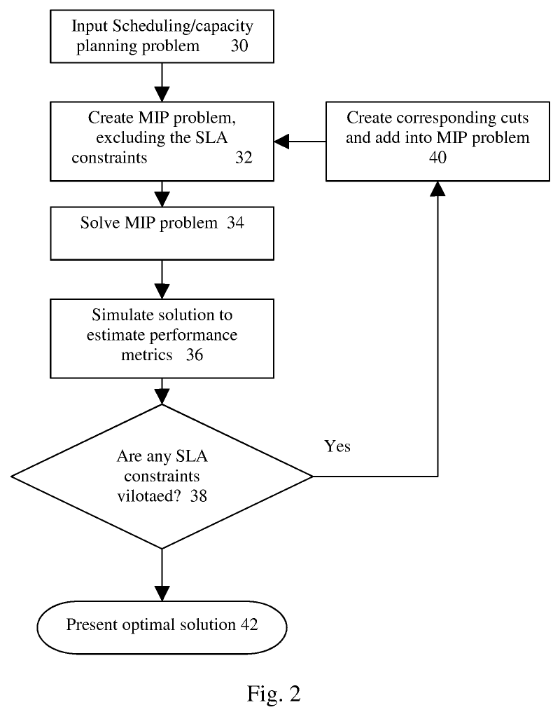

FIG. 2 illustrates a flow chart of an algorithm for solving workforce scheduling or capacity planning, according to some embodiments of the present invention, where calculating the number of workers and skills required in order to supply the adequate level of service, determining the number of workers required at a given period of time and assigning specific workers subject to specific constraints is concurrently solved by constructing and solving a corresponding MIP problem, and employing a stochastic model to evaluate service levels obtained when applying the solution of the MIP problem.

The Scheduling/Capacity Planning problem is input 30. A corresponding MIP problem is created, excluding SLA constraints 32.

The MIP problem is solved 34 by a MIP solver and a solution is attained. The solution attained from the MIP solve undergoes simulation 36 in order to estimate the attained service levels

It is determined whether the solution involves violations to SLA constraints 38, and if there are violated SLA constraints corresponding cuts (new linear constraints) are created and added into the MIP problem 40 and a new iteration commences (the MIP problem is updated to include the cuts, see 32).

If no SLA constraints are violated, the last solution is returned and selected as the global optimal solution 42.

Alternatively, a solution with a desired level of non-violated work constraints may be selected.

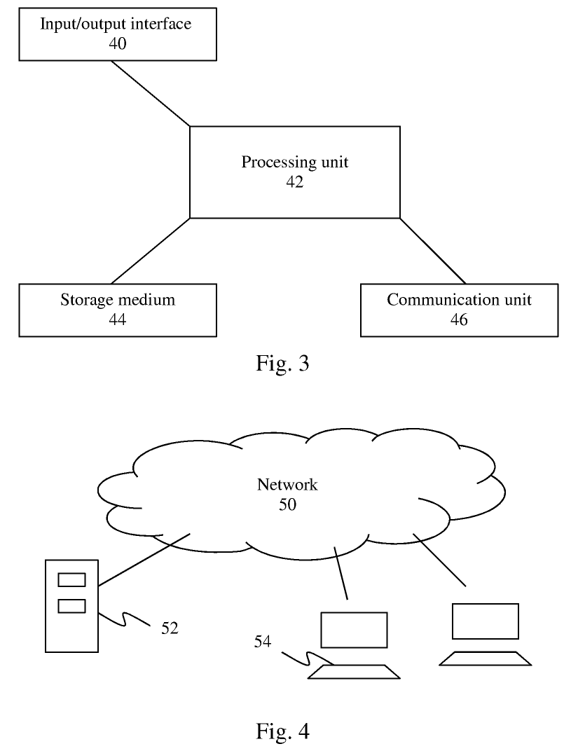

FIG. 3 illustrates an automated system for optimization of a workforce, according to embodiments of the present invention. The system, such as, for example, for example a computer device, may include an input/output unit 40, which may include, for example, a keyboard, a pointing device, a touch screen, a printer and a monitor. The system also includes processing unit 42, which may include a single processor or a plurality of processors, storage medium 44, which may include, for example, a hard-disk, flash memory, floppy disk, disk-on-key, on which a computer executable program may be stored, which includes instructions to perform a method according to embodiments of the present invention. A communication unit 46 may be provided for communicating with another system across a communication line or a network over communication wire or wires or wirelessly.

FIG. 4 illustrates an automated system for optimization of a workforce, according to embodiments of the present invention, implemented in a communication network.

A server 52, which includes some or all of the system components of the system illustrated in FIG. 3, stores and runs a computer executable program which includes instructions to perform a method according to embodiments of the present invention. End-user stations 54, which may be, for example, Personal Computers (PCs) or workstations, may be used, separately or jointly, for inputting required data of a scheduling or a capacity planning problem and for outputting a solution. The end-user stations 54 may communicate with server 52 over communication network 50, such as, for example, an intranet, or the Internet.

What is claimed is:

1. A computer implemented method for solving a scheduling or capacity planning problem of a workforce of a service center given an anticipated workload, the method comprising the steps of:
calculating the number of workers and skills required in order to supply the adequate level of service;
determining the number of workers required at a given period of time; and
assigning specific workers subject to specific constraints to a specific period of time, by constructing and solving a mixed integer programming problem,
wherein the steps of calculating, determining and assigning are implemented in either of
a) computer hardware configured to perform said steps;
b) computer software embodied in a non-transitory, tangible, computer-readable storage medium.

2. A computer implemented method as claimed in claim 1, wherein both steps of determining the number of workers required at a given period of time and assigning specific workers subject to specific constraints to a specific period of time, are performed concurrently by constructing and solving a mixed integer programming problem corresponding to both steps.

3. A computer implemented method as claimed in claim 1, wherein the three steps of calculating the number of workers and skills required in order to supply the adequate level of service, determining the number of workers required at a given period of time and assigning specific workers subject to specific constraints to a specific period of time, are performed concurrently by constructing and solving a mixed integer programming problem corresponding to the three steps and employing a stochastic model to evaluate service levels obtained when applying the solution of the mixed integer programming problem.

4. A computer implemented method as claimed in claim 3, comprising iteratively repeating the solving the mixed integer programming problem and employing the stochastic model, and selecting a solution with a desired level while not violating work constraints.

5. A computer implemented method as claimed in claim 4, wherein the work constraints are selected from a group of constraints consisting of anticipated workload, business objectives, desired specific level, scheduling rules, minimum and maximum working hours, fair allocation of popular and unpopular shifts and attributes of individuals of the workforce.

6. A computer implemented method as claimed in claim 3, wherein the stochastic model is a simulation model.

7. A computer program product stored on a non-transitory tangible computer readable storage medium for optimizing the work of a workforce given an anticipated workload, the computer program product comprising:
computer useable program code for calculating the number of workers and skills required in order to supply the adequate level of service;
computer useable program code for determining the number of workers required at a given period of time; and
computer useable program code for assigning specific workers subject to specific constraints to a specific period of time, by constructing and solving a mixed integer programming problem.

8. A computer program product as claimed in claim 7, wherein the computer useable program code for determining the number of workers required at a given period of time, and the computer useable program code for assigning specific workers subject to specific constraints to a specific period of time, by constructing and solving a mixed integer programming problem comprise constructing and solving a mixed integer programming problem corresponding to the determining the number of workers required at a given period of time, and the assigning specific workers subject to specific constraints to a specific period of time.

9. A computer program product as claimed in claim 7, wherein the computer useable program code for calculating the number of workers and skills required in order to supply the adequate level of service; the computer useable program code for determining the number of workers required at a given period of time; and the computer useable program code for assigning specific workers subject to specific constraints to a specific period of time, by constructing and solving a mixed integer programming problem comprise constructing and solving a mixed integer programming problem corresponding to the calculating the number of workers and skills required in order to supply the adequate level of service, the determining the number of workers required at a given period of time, and the assigning specific workers subject to specific constraints to a specific period of time, and employing a stochastic model to evaluate service levels obtained when applying the solution of the linear programming problem.

10. A computer program product as claimed in claim 9, comprising computer usable program code for iteratively repeating the solving the mixed integer programming problem and employing the stochastic model, and selecting a solution with a desired level while not violating work constraints.

11. A computer program product as claimed in claim 10, wherein the work constraints are selected from a group of constraints consisting of anticipated workload, business objectives, scheduling rules, minimum and maximum working hours, fair allocation of popular and unpopular shifts, desired specific level and attributes of individuals of the workforce.

12. A computer program product as claimed in claim 9, wherein the stochastic model is a simulation model.

13. A data processing system comprising:
a processor;
a computer usable medium connected to processor, wherein the computer usable medium contains a set of instructions for solving a scheduling or capacity planning problem of a workforce of a service center given an anticipated workload, wherein the processor is adapted:
to carry out a set of instructions to calculate the number of workers and skills required in order to supply the adequate level of service;
to determine the number of workers required at a given period of time; and
to assign specific workers subject to specific constraints to a specific period of time, by constructing and solving a mixed integer programming problem.

14. A data processing system as claimed in claim 13, wherein the processor is adapted to determine the number of workers required at a given period of time and assign specific workers subject to specific constraints to a specific period of time concurrently by constructing and solving a mixed integer programming problem.

15. A data processing system as claimed in claim 13, wherein the processor is adapted to calculate the number of workers and skills required in order to supply the adequate level of service, determine the number of workers required at a given period of time and assign specific workers subject to specific constraints to a specific period of time concurrently by constructing and solving a mixed integer programming problem and employing a stochastic model to evaluate service levels obtained when applying the solution of the mixed integer programming problem.

16. A data processing system as claimed in claim 15, wherein the processor is further adapted to iteratively repeat the solving the mixed integer programming problem and employing the stochastic model, and select a solution with a desired level while not violating work constraints.

17. A data processing system as claimed in claim 16, wherein the work constraints are selected from a group of constraints consisting of anticipated workload, business objectives, scheduling rules, minimum and maximum working hours, fair allocation of popular and unpopular shifts, desired specific level and attributes of individuals of the workforce.

18. A data processing system as claimed in claim 15, wherein the stochastic model is a simulation model.
